(19) United States
(12) Patent Application Publication
(10) Pub. No.: US 2025/0046233 A1
(43) Pub. Date: Feb. 6, 2025

(54) DISPLAY SCREEN COMPRISING DISPLAY PIXELS WITH LIGHT-EMITTING DIODES

(71) Applicant: Parc d'Entreprises Sud Galaxie, Echirolles (FR)

(72) Inventors: Frédéric Mercier, Coublevie (FR); Hugues Lebrun, Coublevie (FR)

(73) Assignee: Parc d'Entreprises Sud Galaxie, Echirolles (FR)

(21) Appl. No.: 18/719,774

(22) PCT Filed: Dec. 14, 2022
(86) PCT No.: PCT/EP2022/085752

§ 371 Date: Jun. 13, 2024

(30) Foreign Application Priority Data
Dec. 22, 2021 (FR) 2114277

(51) Int. Cl. G09G 3/32

(52) U.S. Cl. CPC G09G 3/32; G09G 2300/0814; G09G 2300/0842; G09G 2310/08; G09G 2330/02

(57) ABSTRACT

A display screen including display circuits each including a light-emitting diode, a controllable current source powering the light-emitting diode, and a driver circuit adapted to delivering a pulse-width modulated signal for controlling the current source; first, second, and third electrodes coupled to the driver circuits; a circuit for delivering a selection signal on each first electrode; a circuit for delivering analog data signals on the second electrodes; a circuit for delivering a voltage for powering the light-emitting diodes on the third electrodes, wherein each selection signal or the power supply voltage includes spaced-apart phases, each containing an analog signal periodic per interval used for the control of the current source.

The present patent application claims the priority benefit of French patent application FR21/14277 which is herein incorporated by reference.

### TECHNICAL BACKGROUND

The present disclosure generally concerns a display screen having display pixels comprising light-emitting diodes.

### PRIOR ART

A pixel of an image corresponds to the unit element of the image displayed by a display screen. For the display of color images, the display screen generally comprises, for the display of each pixel of the image, at least three light sources, which each emit a light radiation substantially in a single color (for example, red, green, and blue). The superposition of the radiations emitted by these three light sources provides the observer with the colored sensation corresponding to the pixel of the displayed image. There is called display pixel of the display screen indifferently all the components used for the emission of all the light radiations allowing the display of a pixel of an image or only all the components used for the emission of one of the light radiations allowing the display of a pixel of an image. The light sources of the display pixels may comprise light-emitting diodes.

The display pixels may be distributed in an array, each display pixel being located at the intersection of a row (or line) and of a column of the array. Generally, each row of display pixels is successively selected, and the display pixels of the selected row are programmed to display the desired image pixels.

An active array is a screen drive architecture enabling to maintain all the pixel rows active for the entire duration of an image, conversely to arrays called passive, where each row is only active for a time T=Tframe/N (where Tframe is the duration of the image and N is the number of rows of the screen). This enables to increase the luminosity of the display screen. Further, it is possible to send low voltage or current levels onto the array control lines, which enables to display more significant data flows.

In the context of a screen based on light-emitting diodes of micrometer-range dimensions, the size of the light-emitting diodes is generally smaller than the surface area available on the screen for the image pixel due to the high intrinsic luminosity of light-emitting diodes. A method of manufacturing a display screen comprises depositing these unit light-emitting diodes on a support, also called slab, containing the drive electronics. Another manufacturing method comprises using display pixels comprising light-emitting diodes and a circuit for controlling these light-emitting diodes. It is then spoken of smart pixels. This particularly enables to simplify the forming of an active array, since the control electronics of the light-emitting diodes of the display pixel is for the most part embedded on the display pixel. Document WO 2018/185433 describes an example of a smart pixel.

It is desirable for the dimensions of the display pixels to be as small as possible to decrease the quantity of semiconductor materials forming the display pixels and thus decrease the manufacturing costs of these display pixels. However, the bonding of display pixels of small dimensions to the slab may then be difficult, in particular to ensure a proper electric connection between conductive pads of the display pixels and conductive tracks of the slab. This problem is all the more critical regarding the current trend towards the increase of the number of display pixels of the screen.

For a smart pixel, the number of conductive pads of the smart pixel, used for the electric connection of the smart pixel to the slab, generally imposes the dimensions of the smart pixel, particularly due to the minimum size of these pads and to the minimum space to be provided between these pads. It is thus desirable to decrease the number of conductive pads.

It is known to control a light-emitting diode by pulse-width modulation, also called PWM control. This type of control comprises conducting successive current pulses of constant intensity through the light-emitting diode, the pulses being cyclically repeated, the duty cycle determining the light intensity emitted by the light-emitting diode. Such a control advantageously enables to operate the light-emitting diode at its optimum operating point where the efficiency of the light-emitting diode, equal to the ratio of the light power emitted by the light-emitting diode to the electric power consumed by the light-emitting diode, is maximum.

An example of a PWM control method requires an analog reference signal, generally periodic, varying continuously between a minimum value and a maximum value. An example of such an analog reference signal comprises a succession of voltage ramps. The implementation of such a PWM control method with smart pixels has the disadvantage that an additional conductive pad must be provided for each smart pixel for the transmission of the analog reference signal.

### SUMMARY OF THE INVENTION

An object of an embodiment is to provide display pixels comprising light-emitting diodes for a display screen overcoming all or part of the disadvantages of existing display pixels comprising light-emitting diodes.

Another object of an embodiment is for the control circuits of the display screen to implement a pulse-width modulation.

An object of an embodiment is that the number of conductive pads of the display pixel is decreased.

Another object of an embodiment is that the display pixels have dimensions smaller than 200 μm.

An embodiment provides a display screen comprising:
display circuits, each display circuit comprising a light-emitting diode, a controllable current source powering the light-emitting diode, and a driver circuit adapted to delivering a signal, pulse-width modulated, for controlling the current source;
first electrodes coupled to the driver circuits;
a circuit for delivering a selection signal on each first electrode;
second electrodes coupled to the driver circuits;
a circuit for delivering analog data signals on the second electrodes, the driver circuit of each display circuit comprising a circuit for storing the data signal received by the driver circuit and a circuit for comparing the analog data signal and an analog signal periodic per interval adapted to delivering the pulse-width modulated control signal;
third electrodes coupled to the driver circuits; and
a circuit for delivering a voltage for powering the light-emitting diodes on the third electrodes,
wherein each selection signal or the power supply voltage comprises spaced-apart phases, each containing the analog signal periodic per interval.

This enables to decrease the number of electrodes connected to the display circuits and thus the number of connection pads to be provided per display circuit.

According to an embodiment, each selection signal comprises successive pulses, each display circuit further comprises a detection circuit configured to detect each pulse of the selection signal that the display circuit receives and the storage circuit of the display circuit is configured to store the data signal received by the driver circuit on detection of each pulse. The storage of the data signal is thus controlled by the pulses of the selection signal.

According to an embodiment, each selection signal comprises the phases interposed in time between two successive pulses. The selection signal comprises both the pulses used for the selection of the display circuits and the analog signal periodic per interval used for the pulse-width modulation control of the light-emitting diodes. This enables to keep a substantially constant power supply voltage during the operation of the display screen.

According to an embodiment, the detection circuit is configured to differentiate, in the selection signal, the pulses from the analog signal periodic per interval. The distinction between the pulses and the analog signal periodic per interval is advantageously performed internally by each display circuit.

According to an embodiment, the maximum amplitude of the pulses of the selection signal is greater than the maximum amplitude of the analog signal periodic per interval. The distinction between the pulses and the analog signal periodic per interval may advantageously be performed by one or a plurality of comparison operations.

According to an embodiment, the detection circuit comprises two successive inverters having different inversion thresholds. The structure of the detection circuit is advantageously particularly simple.

According to an embodiment, the period of the analog signal periodic per interval on each interval is different from the duration of each pulse. The distinction between the pulses and the analog signal periodic per interval is thus not or little dependent on the variations of the levels of the pulses and of the periodic analog signal.

According to an embodiment, the waveform of the pulses of the selection signal is different from the waveform of the analog signal periodic per interval over a period of the analog signal periodic per interval. The distinction between the pulses and the analog signal periodic per interval is thus not or little dependent on the variations of the levels of the pulses and of the periodic analog signal.

According to an embodiment, the detection circuit comprises a high-pass filter or a low-pass filter.

According to an embodiment, each driver circuit comprises a circuit for delivering a binary signal containing pulses simultaneous with the pulses of the selection signal.

According to an embodiment, the pulses and the phases of the analog signal periodic per interval are of signs opposite with respect to a reference value. The distinction between the pulses and the analog signal periodic per interval is thus facilitated.

According to an embodiment, the signal periodic per interval is triangular.

According to an embodiment, the signal periodic per interval contains only successive ascending ramps or only successive descending ramps.

According to an embodiment, the driver circuit is configured to deliver the control signal in a first state when the analog data signal is greater than the analog signal periodic per interval and to deliver the control signal in a second state when the analog data signal is lower than the analog signal periodic per interval.

An embodiment also provides an electronic system for delivering signals intended for an array of display circuits, each display circuit comprising a light-emitting diode, a controllable current source powering the light-emitting diode, and a driver circuit adapted to delivering a signal, pulse-width modulated, for controlling the current source, that array further comprising first, second, and third electrodes coupled to the driver circuits, the system comprising:
a circuit for delivering a selection signal on each first electrode;
a circuit for delivering analog data signals on the second electrodes, the driver circuit of each display circuit comprising a circuit for storing the data signal received by the driver circuit and a circuit for comparing the analog data signal and an analog signal periodic per interval adapted to delivering the pulse-width modulated control signal; and
a circuit for delivering a voltage for powering the light-emitting diodes on the third electrodes,
wherein each selection signal or the power supply voltage comprises spaced-apart phases, each containing the analog signal periodic per interval.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 partially and schematically shows an example of a display screen;

FIG. 2 is a very simplified cross-section view of an example of a display pixel;

FIG. 3 is a bottom view of the display pixel of FIG. 2;

FIG. 4 shows an example of a block diagram of the display pixel of FIG. 2;

FIG. 5 shows examples of timing diagrams of signals of the display pixel of FIG. 2 for a row of display pixels according to an embodiment of an operating method of the display screen;

FIG. 6 shows examples of timing diagrams of signals of the display pixel of FIG. 2 for three successive rows of display pixels according to an embodiment of an operating method of the display screen;

FIG. 7 shows an example of timing diagram of a signal of the display pixel of FIG. 2 illustrating an embodiment of a method of detecting pulses of the signal;

FIG. 8 shows an example of timing diagram of a signal of the display pixel of FIG. 2 illustrating another embodiment of a method of detecting pulses of the signal;

FIG. 9 shows an example of timing diagram of a signal of the display pixel of FIG. 2 illustrating another embodiment of a method of detecting pulses of the signal;

FIG. 10 shows an electric diagram of an embodiment of a portion of the display pixel illustrated in FIG. 4;

FIG. 11 shows an electric diagram of an embodiment of another portion of the display pixel illustrated in FIG. 4;

FIG. 12 shows examples of timing diagrams of signals of the display pixel of FIG. 2 for a row of display pixels according to another embodiment of an operating method of the display pixel;

FIG. 13 shows examples of timing diagrams of signals of the display pixel of FIG. 2 for a row of display pixels according to another embodiment of an operating method of the display pixel;

FIG. 14 shows an electric diagram of another embodiment of a portion of the display pixel illustrated in FIG. 4;

FIG. 15 shows examples of timing diagrams of signals of the display pixel of FIG. 2 for a row of display pixels according to another embodiment of an operating method of the display pixel;

FIG. 16 shows an electric diagram of another embodiment of a current source of the display pixel illustrated in FIG. 4;

FIG. 17 shows an electric diagram of another embodiment of a portion of the display pixel illustrated in FIG. 4;

FIG. 18 shows a timing diagram obtained by simulation of a signal of the display screen during a first operating phase;

FIG. 19 shows a timing diagram obtained by simulation of other signals of the display screen during the first operating phase;

FIG. 20 shows a timing diagram obtained by simulation of a signal of the display screen during a second operating phase;

FIG. 21 shows a timing diagram obtained by simulation of other signals of the display screen during the second operating phase;

FIG. 22 is a drawing similar to FIG. 20 during the emission of a radiation of minimum intensity by the display pixel;

FIG. 23 is a drawing similar to FIG. 21 during the emission of a radiation of minimum intensity by the display pixel;

FIG. 24 is a drawing similar to FIG. 20 during the emission of a radiation of maximum intensity by the display pixel; and

FIG. 25 is a drawing similar to FIG. 21 during the emission of a radiation of maximum intensity by the display pixel.

### DESCRIPTION OF THE EMBODIMENTS

Like features have been designated by like references in the various figures. In particular, the structural and/or functional features that are common among the various embodiments may have the same references and may dispose identical structural, dimensional and material properties. For the sake of clarity, only the steps and elements that are useful for an understanding of the embodiments described herein have been illustrated and described in detail.

In the following description, when reference is made to terms qualifying absolute positions, such as terms “front”, “rear”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings or to a display screen in a normal position of use.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

Further, there is called “binary signal” a signal which alternates between a first constant state, for example, a low state, noted “0”, and a second constant state, for example, a high state, noted “1”. The high and low states of different binary signals of a same electronic circuit may be different. In practice, the binary signals may correspond to voltages which may not be perfectly constant in the high or low state.

Further, in the following description, there are called “power terminals” of an insulated gate field-effect transistor, or MOS transistor, the source and the drain of the MOS transistor.

Further, unless indicated otherwise, when it is spoken of a voltage at a conductive pad, the difference between the potential at said conductive pad and a reference potential, for example, the ground, taken as equal to 0 V, is considered.

Further, it is here considered that the terms “insulating” and “conductive” respectively signify “electrically insulating” and “electrically conductive”. Unless specified otherwise, the expressions “around”, “approximately”, “substantially” and “in the order of” signify within 10%, and preferably within 5%.

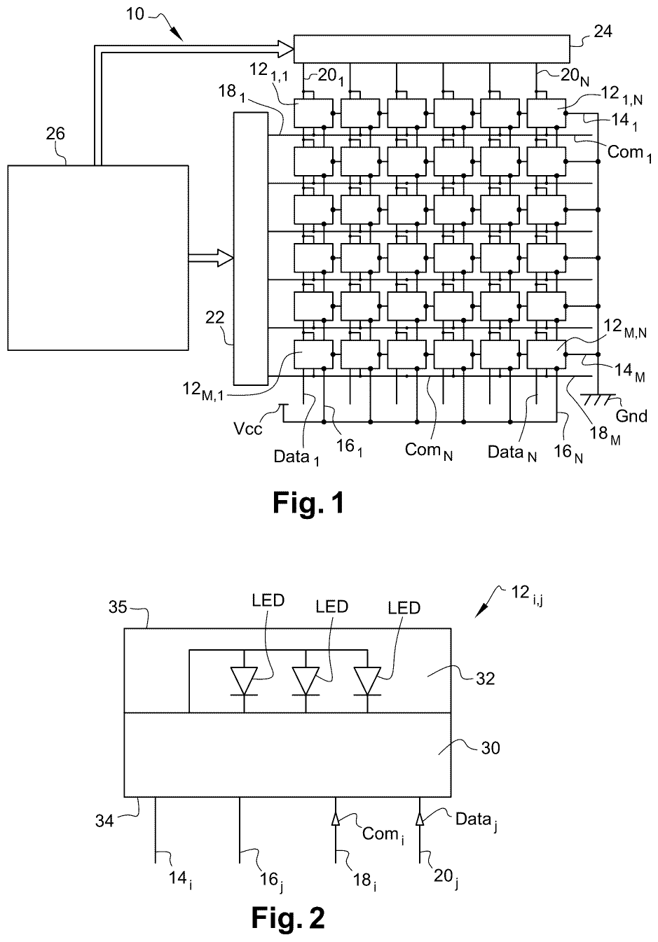

FIG. 1 partially and schematically shows a known example of a display screen 10. Display screen 10 comprises display pixels 12_{i,j}, for example, arranged in M rows and in N columns, M being an integer varying from 1 to 8,000 and N being an integer varying from 1 to 16,000, i being an integer varying from 1 to M, and j being an integer varying from 1 to N. As an example, in FIG. 1, M and N are equal to 6. Each display pixel 12_{i,j} is coupled to a source of a low reference potential Gnd, for example, the ground, via an electrode 14ᵢ and to a source of a high reference potential Vcc via an electrode 16ⱼ. As an example, electrodes 14ᵢ are shown as being aligned along the rows in FIG. 1 and electrodes 16ⱼ are shown as being aligned along the columns in FIG. 1, the reverse layout being possible. The power supply voltage of the display screen corresponds to the voltage between high reference potential Vcc and low reference potential Gnd, and is noted Vcc like the high reference potential. Power supply voltage Vcc particularly depends on the arrangement of the light-emitting diodes and on the technology according to which the light-emitting diodes are manufactured. As an example, power supply voltage Vcc may be in the order of from 4 V to 5 V.

For each row, the display pixels 12_{i,j} in the row are coupled to a row electrode 18ᵢ. For each column, the display pixels 12_{i,j} in the column are coupled to a column electrode 20ⱼ. Display screen 10 comprises a selection circuit 22 coupled to row electrodes 18ᵢ and adapted to delivering a selection and reference signal Comᵢ on each row electrode 18ᵢ. Display screen 10 comprises a data delivery circuit 24 coupled to column electrodes 20ⱼ and adapted to delivering a data signal Dataⱼ on each column electrode 20ⱼ. Selection circuit 22 and control circuit 24 are controlled by a circuit 26, for example comprising a microprocessor.

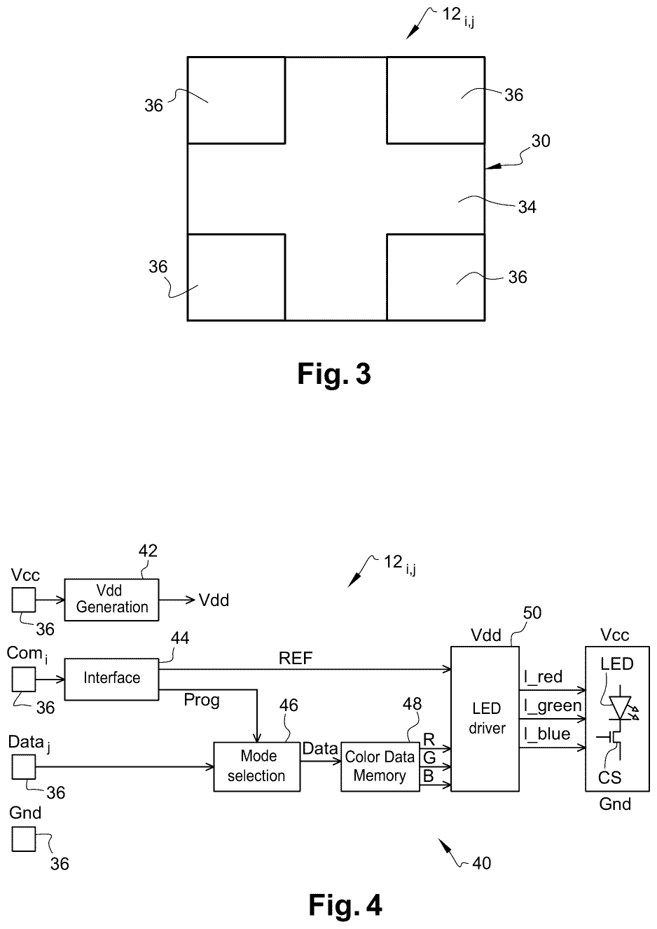

FIG. 2 is a very simplified cross-section view of an example of display pixel 12_{i,j} and FIG. 3 is a bottom view of display pixel 12_{i,j}. Each display pixel 12_{i,j} comprises a control circuit 30 covered with a display circuit 32. Display circuit 32 comprises at least one light-emitting diode LED, three light-emitting diodes LED being shown as an example in FIG. 2. The display pixel comprises a lower surface 34 and an upper surface 35 opposite to lower surface 34, surfaces 34 and 35 being preferably planar and parallel. Control circuit 30 further comprises conductive pads 36, not shown in FIG. 2, on lower surface 34. Control circuit 30 may correspond to an integrated circuit comprising electronic components, particularly insulated gate field effect transistors, also called MOS transistors, or thin film transistors, also called TFT transistors. Preferably, display circuit 32 only comprises light-emitting diodes LED and the conductive elements of these light-emitting diodes LED and control circuit 30 comprises all the electronic components necessary for the control of the light-emitting diodes LED of display circuit 32. As a variant, display circuit 32 may also comprise other electronic components in addition to light-emitting diodes LED. Light-emitting diodes LED may be 2D light-emitting diodes, also called planar light-emitting diodes, comprising a stack of planar layers, or 3D light-emitting diodes, each comprising a three-dimensional semiconductor element covered with an active area. In FIG. 2, light-emitting diodes LED are shown as connected with a common anode. It may however be desirable to arrange light-emitting diodes LED according to another configuration. As an example, light-emitting diodes LED may be connected with a common cathode, or be connected independently from one another.

According to an embodiment, display pixel 12_{i,j} comprises three light sources emitting light at first, second, and third wavelengths. According to an embodiment, the first wavelength corresponds to blue light and is within the range from 430 nm to 490 nm. According to an embodiment, the second wavelength corresponds to green light and is within the range from 510 nm to 570 nm. According to an embodiment, the third wavelength corresponds to red light and is within the range from 600 nm to 720 nm. As a variant, display pixel 12_{i,j} may only comprise a light source emitting light at the first, second, or third wavelengths, or only two light sources emitting light at two wavelengths among the first, second, and third wavelengths.

Each conductive pad 36 is intended to be connected to one of the electrodes 14ᵢ, 16ⱼ, 18ᵢ, 20ⱼ schematically shown in FIG. 2. A first conductive pad 36 is coupled to the source of low reference potential Gnd. A second conductive pad is coupled to the source of high reference potential Vcc. A third conductive pad 36 is coupled to row electrode 18ᵢ and receives selection and reference signal Comᵢ. A fourth conductive pad 36 is coupled to column electrode 20ⱼ and receives data signal Dataⱼ. The dimensions of conductive pads 36 and the arrangement of conductive pads 36 on surface 34 are particularly imposed by the rules of design of display pixel 12_{i,j} and by the method of assembly of display pixels 12_{i,j} in display screen 10.

FIG. 4 shows an example of block diagram of a display pixel 12_{i,j} of display screen 10.

According to an example, display pixel 12_{i,j} comprises a light-emitting diode or light-emitting diodes, a single light-emitting diode LED being shown as an example in FIG. 4. Each light-emitting diode LED is series-coupled to a controllable current source CS, for example comprising a MOS transistor. In the present example, for each light-emitting diode LED, the anode of light-emitting diode LED is for example coupled to the conductive pad 36 receiving high reference potential Vcc and the cathode of light-emitting diode LED is for example coupled to a terminal of controllable current source CS, the other terminal of controllable current source CS being coupled to the conductive pad 36 receiving low reference potential Gnd.

Display pixel 12_{i,j} further comprises a circuit 40 for driving controllable current source CS. Driver circuit 40 may particularly comprise electronic components such as MOS transistors. It may be desirable to use a decreased power supply voltage, lower than 4 V, for example in the order of 1 V or of 1.8 V, to power at least some of the electronic components of driver circuit 40, this decreased power supply voltage enabling to use low-voltage transistor, of decreased size. For this purpose, display pixel 12_{i,j} may comprise a circuit 42 (Vdd Generation) for delivering, based on power supply voltage Vcc, a decreased power supply voltage Vdd particularly used for the power supply of some of the components of driver circuit 40. Circuit 42 for example comprises a voltage divider.

According to an embodiment, selection and reference signal Comᵢ, received at one of the conductive pads 36 of each display pixel 12_{i,j}, is an analog signal. Further, data signal Dataⱼ, received at one of the conductive pads 36 of each display pixel 12_{i,j}, is an analog signal.

Driver circuit 40 comprises a circuit 44 (Interface) coupled to conductive pad 36 receiving selection and reference signal Comᵢ and delivering, based on signal Comᵢ, a selection signal Prog and an analog reference signal REF adapted for the performing of a PWM control. Driver circuit 40 comprises a circuit 46 (Mode selection) receiving data signal Dataⱼ and selection signal Prog, and configured to deliver an analog signal Data to a storage circuit 48 (Color Data Memory). Storage circuit 48 is configured to store R, G, B color signals representative of the image pixel to be displayed. Circuit 50 is adapted to controlling the controllable current sources CS coupled to light-emitting diodes LED with control signals obtained from the R, G, B analog control signals and from analog reference signal REF. As a variant, in the case of a monochromatic display pixel, storage circuit 48 is configured to store a single analog color signal and circuit 50 is adapted to controlling the controllable current sources CS coupled to light-emitting diodes LED with control signals obtained from the analog color signal and from the analog reference signal.

As will be described hereafter, to limit the number of conductive pads 36 per display pixel 12_{i,j}, signal Comᵢ allows both the selection of display pixel 12_{i,j} for the storage of a data signal Data and the delivery of the analog reference signal used for the PWM control of the light-emitting diodes.

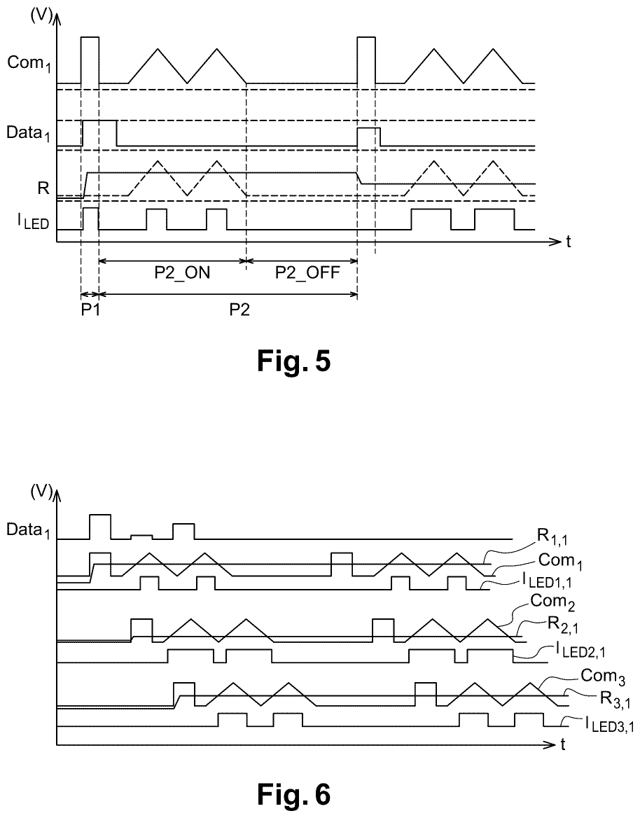

FIGS. 5 and 6 show timing diagrams of signals received by display pixels 12_{i,j} for an embodiment of a method of displaying an image on display screen 10. For illustration purposes, in FIG. 5, there have only been shown signals associated with the row of rank 1 and the column of rank 1 of display screen 10 and in FIG. 6, there have only been shown signals associated with the column of rank 1 and the successive columns of rank 1, 2, and 3 of display screen 10.

In the present embodiment, potentials Vcc and Gnd, not shown in FIGS. 5 and 6, are substantially constant during the operation of display screen 10. The image pixels of a new image to be displayed are successively displayed from the row of rank 1 to the row of rank M. There is called frame duration T the duration separating two successive selections of the same row of display screen 10. The display of a new image pixel by a display pixel 12_{1,j}, j varying from 1 to N, of the row of rank i comprises a first phase P1 followed by a second phase P2. During phase P1, analog data signals Dataⱼ are transmitted to the display pixels 12_{1,j} of the row of rank i, only signal Dataᵢ being shown in FIG. 5. Each display pixel 12_{i,j} stores a new value of the R, G, or B analog color signal based on the received analog data signal Dataⱼ. During second phase P2, the light-emitting diodes of each display pixel 12_{1,j} are controlled from the stored R, G, B color signals. In the case where display pixel 12_{i,j} comprises light-emitting diodes emitting different colors, display pixel 12_{i,j} can receive the data signals Dataⱼ corresponding to the different colors successively during phase P1 and the light-emitting diodes of each display pixel 12_{1,j} are controlled from the new R, G, B color signals obtained from data signals Dataⱼ during the next second phase P2.

During first phase P1, selection and reference signal Comᵢ is set to a high level, substantially constant, thus forming a voltage pulse. The pulse of signal Comᵢ is detected by the circuit 44 of each display pixel 12_{i,j} of the row of rank i and thus enables to select the display pixels 12_{i,j} of this row, while the display pixels of the other rows are not selected. According to an embodiment, the duration of each pulse is shorter than the duration of the frame divided by the number of rows to be selected, preferably shorter than 100 ρs. In particular, circuit 44 delivers a signal Prog to circuit 46, signal Prog being for example a binary signal which is held at state “1” for the duration of the pulse of signal Comᵢ. During first phase P1, data signals Dataⱼ are transmitted onto column electrodes 20ⱼ. Each data signal Dataⱼ may correspond to an analog signal capable of taking a constant value from a minimum value to a maximum value. Circuit 46, selected by signal Prog at state “1”, delivers signal Dataⱼ which is stored in the circuit 50 of display pixel 12_{1,j} in the form of an R, G, or B signal having its value depending on signal Dataⱼ, the signal R_{1,1} stored by display pixel 12_{1,1}, and the current I_{LED1,1} crossing the light-emitting diode of display pixel 12_{1,1}, being shown as an example in FIG. 5 and the signals R_{1,1}, R_{2,1}, and R_{3,1} respectively stored by display pixels 12_{1,1}, 12_{2,1}, and 12_{3,1} and the currents I_{LED1,1}, I_{LED2,1}, and I_{LED3,1}, respectively crossing the light-emitting diodes of display pixels 12_{1,1}, 12_{2,1}, and 12_{3,1} being shown as an example in FIG. 6. As shown in FIG. 6, the timing diagrams of signals Com₂ and Com₃ are similar to the timing diagram of signal Comᵢ although shifted in time. The end of the first phase P1 for a row may correspond to the beginning of the first phase P1 for the next row.

According to an embodiment, the light-emitting diodes of display pixel 12_{1,j} are controlled by pulse-width modulation. For third purpose, during a first portion P2_ON of second phase P2, selection and reference signal Comᵢ periodically varies, exhibiting a succession of identical patterns which are detected by the circuit 44 of each display pixel 12_{i,j} of the row of rank i. Circuit 44 sets signal Prog to state “0” and transmits the succession of patterns to circuit 50 (analog reference signal REF) for the control of light-emitting diodes LED by pulse-width modulation. As an example, in FIG. 5, each pattern comprises an ascending voltage ramp followed by a descending voltage ramp. According to another example, each pattern only comprises one ascending voltage ramp or only one descending voltage ramp. Generally, each pattern comprises a determined voltage variation curve, for example, an exponential growth curve, a sinusoidal curve, etc. The shape of the pattern may for example include eye sensitivity compensations, in particular a gamma correction. The pattern repetition frequency on each phase P2_OFF enables to have between 1 and 1,000 pattern cycles per phase P2_OFF.

The circuit 50 of display pixel 12_{i,j} controls light-emitting diode LED or light-emitting diodes LED based on the comparison between the stored R, G, or B analog signal and analog reference signal REF. As an example, current source CS is turned off when the stored R, G, or B analog signal is greater than analog reference signal REF, which results in a zero current I_{LED} powering the light-emitting diode, and current source CS is turned on when the stored R, G, or B analog signal is smaller than analog reference signal REF, which results in a current I_{LED} powering the light-emitting diode at a constant non-zero value.

During a second portion P2_OFF of second phase P2, selection and reference signal Comᵢ is maintained at a constant level, for example, a low level, so that the light-emitting diodes LED of the display pixels in the row are off. The duration of second portion P2_OFF may vary from 0% to 100% of the duration of second phase P2. In particular, second portion P2_OFF may not be present. According to an embodiment, the duration of each phase P2 is equal to the duration of the frame Tframe decreased by the duration of phase P1.

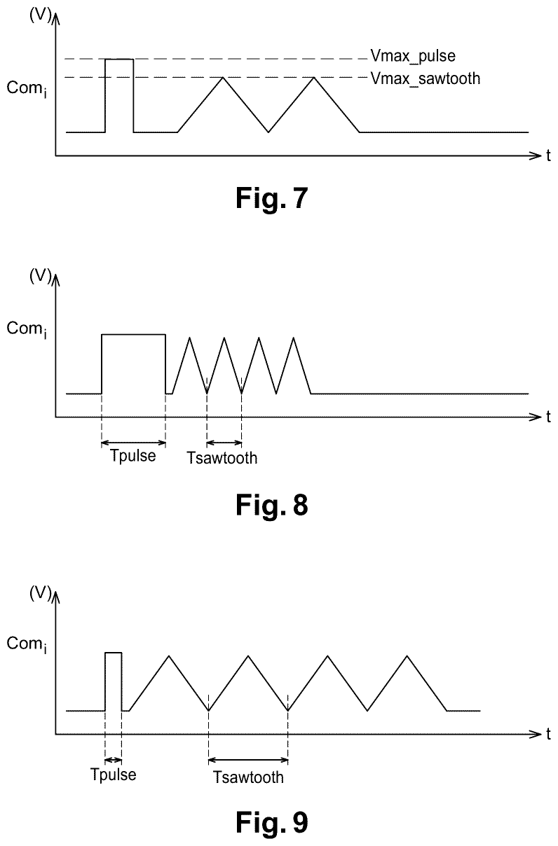

FIGS. 7, 8, and 9 show timing diagrams of signal Comᵢ illustrating embodiments of a method of detection of the pulses of signal Comᵢ.

According to an embodiment illustrated in FIG. 7, the difference between the level Vmax_pulse of the pulse of signal Comᵢ and the maximum value Vmax_sawtooth of signal Comᵢ during the succession of patterns is greater than the threshold allowing the detection of the pulse by circuit 44, preferably greater than 100 mV, and the detection of a pulse of signal Comᵢ is performed by an amplitude detection. A pulse of signal Comᵢ is for example detected when signal Comᵢ becomes greater than a threshold.

According to an embodiment illustrated in FIG. 8, the duration Tpulse of the pulse of signal Comᵢ is greater than or equal to the duration Tsawtooth of the pattern which is repeated in the succession of ramps. The detection of a pulse of signal Comᵢ is for example performed by a low-pass filtering of signal Comᵢ. In particular, in this case, the duration Tpulse of the pulse of signal Comᵢ may be equal to duration Tsawtooth. Indeed, the pulse of signal Comᵢ having a shape different from that of the patterns of reference signal REF, it may be detected by a low-pass filtering.

According to an embodiment illustrated in FIG. 9, the duration Tpulse of the pulse of signal Comᵢ is shorter, preferably by at least 30%, than the duration Tsawtooth of the pattern which is repeated in the succession of ramps. The detection of a pulse of signal Comᵢ is for example performed by a high-pass filtering of signal Comᵢ.

According to an embodiment, analog reference signal REF may comprise only the patterns of signal Comᵢ. According to another embodiment, analog reference REF is identical to signal Comᵢ. Indeed, since the duration of the pulse of signal Comᵢ, that is, the duration of phase P1, may be much shorter than the duration of the repetition of the patterns of signal Comᵢ, that is, the duration of the portion P2_ON of phase P2, the light intensity emitted by the light-emitting diodes during phase P1, if they are on, is negligible as compared with that emitted during the portion P2_ON of phase P2.

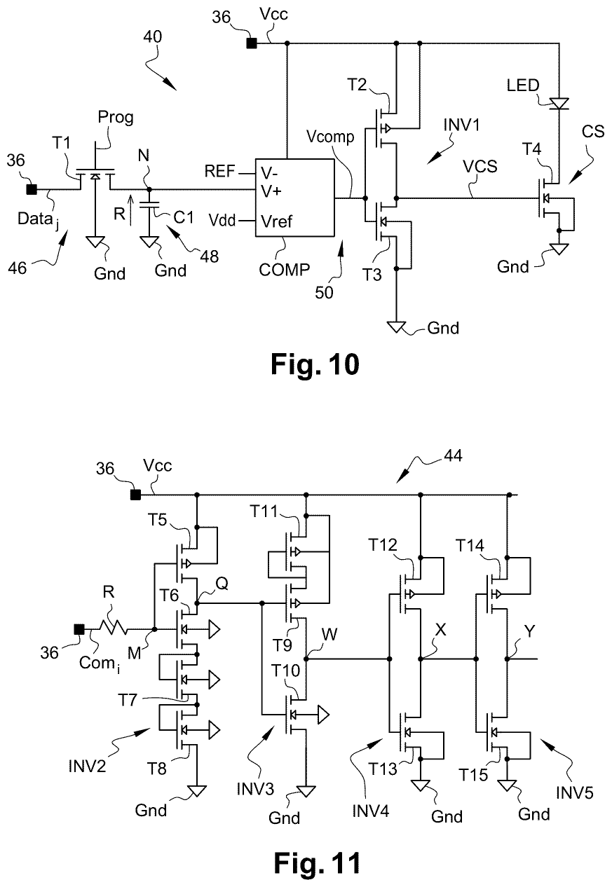

FIG. 10 is an electric diagram of an embodiment of a portion of circuit 40 for driving controllable current source CS, particularly, circuits 46, 48, and 50.

The circuit 46 of driver circuit 40 comprises a first switch T1 coupling the conductive pad 36 receiving data signal Dataⱼ to a node N. Switch T1 is controlled by signal Prog. According to an embodiment, switch T1 is an N-channel MOS transistor, having its gate receiving signal Prog. The circuit 48 of driver circuit 40 comprises a capacitor C1 having a plate coupled, preferably connected, to node N, and a second plate coupled, preferably connected, to the conductive pad receiving low reference voltage Gnd.

The circuit 50 of driver circuit 40 comprise a comparator COMP comprising an input V+ coupled, preferably connected, to node N, an input V− receiving signal REF, which may be identical to signal Comᵢ, an input Vref receiving a constant voltage that may, for example, correspond to decreased reference voltage Vdd when it is present or be obtained from high reference voltage Vcc, particularly when decreased reference voltage Vdd is not present, an input coupled, preferably connected, to the conductive pad 36 receiving high reference voltage Vcc, and an output delivering a binary signal Vcomp. Comparator COMP may comprise a differential pair.

Circuit 50 comprises an inverter INV1 receiving signal Vcomp and delivering a signal VCS of PWM control of current source CS. According to an embodiment, inverter INV1 comprises a P-channel MOS transistor T2 having its source receiving high reference voltage Vcc, having its gate receiving signal Vcomp, and having its drain delivering signal VCS, and an N-channel MOS transistor T3 having its source receiving low reference voltage Gnd, having its gate receiving signal Vcomp, and having its drain connected to the drain of transistor T2.

According to an embodiment, current source CS corresponds to an N-channel MOS transistor T4 having its gate receiving signal VCS, having its source receiving low reference voltage Gnd, and having its drain coupled to the cathode of light-emitting diode LED, the anode of light-emitting diode LED receiving high reference voltage Vcc.

Switch T1 is on when selection signal Prog is at state “1”, for example, equal to voltage Vcc, and switch T1 is off when selection signal Prog is at state “0”, for example, equal to 0 V. When switch T1 is on, capacitor C1 is charged with voltage Dataⱼ via switch T1. The turning off of switch T1 when selection signal Prog is at state “0” prevents a discharge of capacitor C1 through switch T1. Signal Dataⱼ is thus stored in the form of a voltage R across capacitor C1.

Comparator COMP compares the voltage R across capacitor C1 with signal REF. Inverter INV1 delivers signal VCS having its state at “1” or at “0” which is the inverse of the state of signal Vcomp. MOS transistor T4 is in the on state when signal VCS is at “1” and is off when signal VCS is at “0”.

According to an embodiment, when voltage R is greater than voltage REF, signal Vcomp is at “1” and signal VCS is at “0”. Transistor T4 is then turned off and light-emitting diode LED is turned off. When voltage R is smaller than voltage REF, signal Vcomp is at “0” and signal VCS is at “1”. Transistor T4 is then in the on state and light-emitting diode LED is turned on.

FIG. 11 is an electric diagram of an embodiment of circuit 44 adapted to the implementation of the embodiment of the detection method illustrated in FIG. 7.

Circuit 44 comprises a resistor R having a first terminal coupled, preferably connected, to the conductive pad 36 receiving selection and reference signal Comᵢ and having a second terminal coupled, preferably connected, to a node M. Selection circuit 44 comprises four successive inverters INV2, INV3, INV4, and INV5 having different inversion thresholds.

Inverter INV2 comprises a P-channel MOS transistor T5 having its source receiving high reference voltage Vcc, having its gate coupled, preferably connected, to node M, and having its drain coupled, preferably connected, to a node Q, and an N-channel MOS transistor T6 having its gate coupled, preferably connected, to node M, and having its drain coupled, preferably connected, to node Q. Circuit 44 comprises two N-channel MOS transistors T7 and T8, each diode-assembled, arranged in series between the source of low reference potential Gnd and the source of transistor T6.

Inverter INV3 comprises a P-channel MOS transistor T9 having its gate coupled, preferably connected, to node Q, and having its drain coupled, preferably connected, to a node W, and an N-channel MOS transistor T10 having its gate coupled, preferably connected, to node Q, having its drain coupled, preferably connected, to node W, and having its source coupled, preferably connected, to the source of low reference potential Gnd. Circuit 44 comprises a P-channel MOS transistor T11, diode assembled, arranged in series between the source of high reference potential Vcc and the source of transistor T9.

Inverter INV4 comprises a P-channel MOS transistor T12 having its gate coupled, preferably connected, to node W, having its source coupled, preferably connected, to the source of high reference potential Vcc, and having its drain coupled, preferably connected, to a node X, and an N-channel MOS transistor T13 having its gate coupled, preferably connected, to node W, having its drain coupled, preferably connected, to node X, and having its source coupled, preferably connected, to the source of low reference potential Gnd. Inverter INV5 comprises a P-channel MOS transistor T14 having its gate coupled, preferably connected, to node X, having its source coupled, preferably connected, to the source of high reference potential Vcc, and having its drain coupled, preferably connected, to a node Y, and an N-channel MOS transistor T15 having its gate coupled, preferably connected, to node X, having its drain coupled, preferably connected, to node Y, and having its source coupled, preferably connected, to the source of low reference potential Gnd. Node Y delivers signal Prog.

Circuit 44 operates as follows. The potential at node M follows selection and reference signal Comᵢ while having an excursion adapted to the operation of inverter INV2. Considering that all the MOS transistors have the same dimensions, the inversion threshold of inverter INV2 is substantially equal to Vcc/2+2Vd where Vd is the gate-source voltage of diode-assembled transistor T7, Vd also being equal to the drain-source voltage. The inversion threshold of inverter INV3 is substantially equal to Vcc/2-Vd. The inversion threshold of inverter INV4 and of inverter INV5 is substantially equal to Vcc/2. The voltage at node M is in the range from Vcc/2+2Vds to Vcc when signal Comᵢ is at voltage Vmax_pulse. The voltage at node M is smaller than Vcc/2+2Vds when signal Comᵢ is at voltage Vmax_sawtooth. When signal Comᵢ is at voltage Vmax_pulse during a pulse at phase P1, the voltage at node Q is at level “0”, the voltage at node W is at level “1”, the voltage at node X is at level “0”, and the voltage at node Y is at level “1”. Signal Prog thus is at “1”. During the portion P2_ON of phase P2, during the succession of patterns, signal Comᵢ remains smaller than voltage Vmax_sawtooth. The voltage at node Q then is at level “1”, the voltage at node W is at level “0”, the voltage at node X is at level “1”, and the voltage at node Y is at level “0”. Signal Prog thus is at “0”. Inverters INV3, INV4, and INV5 particularly have the purpose of ensuring that signal Prog exhibits a sufficiently steep rising edge and falling edge.

In the embodiment previously described in relation with FIGS. 5 and 6, the light-emitting diodes LED of each display pixel 12_{i,j} are turned off when voltage Dataⱼ is greater than analog reference signal REF. This means that the higher the stored value of signal Dataⱼ, the lower the light intensity emitted by light-emitting diodes LED. For certain applications, it may be desirable for the light-emitting diodes LED of each display pixel 12_{i,j} to be controlled so that the higher the stored value of signal Dataⱼ, the higher the light intensity emitted by light-emitting diodes LED.

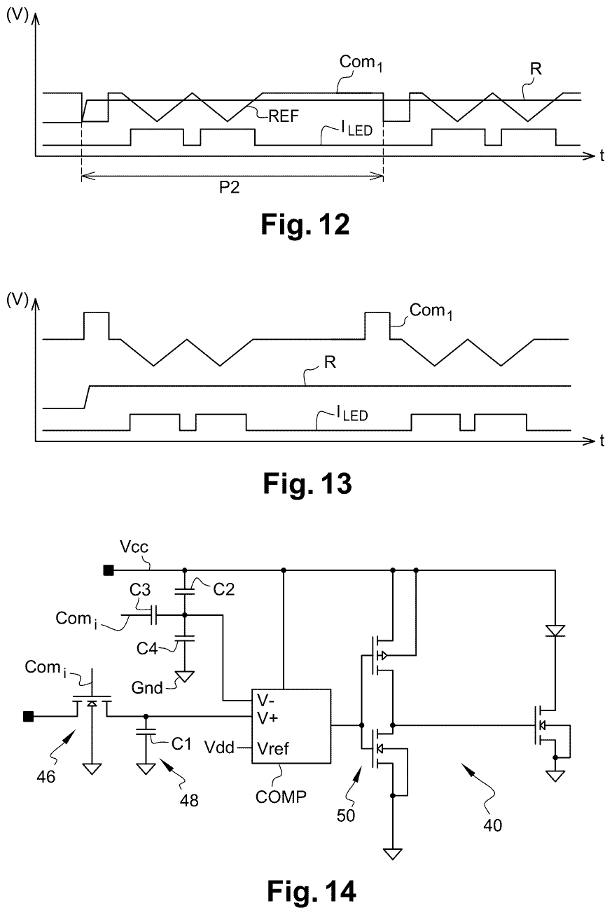

FIG. 12 is a drawing similar to FIG. 5 and shows timing diagrams of signals received by display pixels 12_{i,j} for another embodiment of a method of image display on display screen 10. For illustration purposes, in FIG. 12, only the row of rank 1 has been considered.

The polarity of signal Comᵢ in FIG. 12 is inverted with respect to the polarity of signal Comᵢ in FIG. 5. During phase P2, the light-emitting diodes LED of each display pixel 12_{i,j} are then off, which corresponds to a zero current I_{LED}, when the stored analog signal R is lower than voltage REF and they are on, which corresponds to a current I_{LED} at a high level, when the stored analog signal R is lower than voltage REF. The higher the value of analog signal R, the higher the light intensity emitted by light-emitting diodes LED. Driver circuit 40 may be the same as that previously described in relation with FIGS. 10 and 11.

FIG. 13 is a drawing similar to FIG. 5 and shows timing diagrams of signals received by display pixels 12_{i,j} for another embodiment of a method of image display on display screen 10. For illustration purposes, in FIG. 13, only the row of rank 1 has been considered.

Signal Comᵢ in FIG. 13 is identical to the signal Comᵢ of FIG. 5 with the difference that, during the portion P2_ON of phase P2, signal Comᵢ varies between the zero value and a negative maximum value −Vmax_sawtooth.

FIG. 14 is a drawing similar to FIG. 10 and shows an electric diagram of an embodiment of a portion of circuit 40 for driving controllable current source CS, particularly circuits 46, 48, and 50, adapted to the implementation of the embodiment of the control method illustrated in FIG. 13.

The driver circuit 40 shown in FIG. 13 comprises all the elements of the driver circuit 40 shown in FIG. 10 and further comprises a capacitor C2 having a first plate coupled, preferably connected, to the conductive pad 36 receiving high reference voltage Vcc and having a second plate coupled, preferably connected, to the input V− of capacitor COMP, a capacitor C3 having a first plate receiving signal Com1 and having a second plate coupled, preferable connected, to the negative input V− of comparator COMP, and a capacitor C4 having a first plate coupled, preferably connected, to the negative input V− of comparator COMP and having a second plate coupled, preferably connected, to the source of low reference potential Gnd.

In operation, the signal at input V− of comparator COMP follows the variations of signal Comᵢ while varying between two extreme positive voltage values. An advantage of such embodiment is that circuit 44 may not be present, since signal Comᵢ can be directly used to control the gate of transistor T1.

According to another embodiment, analog reference signal REF is not present on signal Comᵢ but on high reference voltage Vcc or on low reference voltage Gnd.

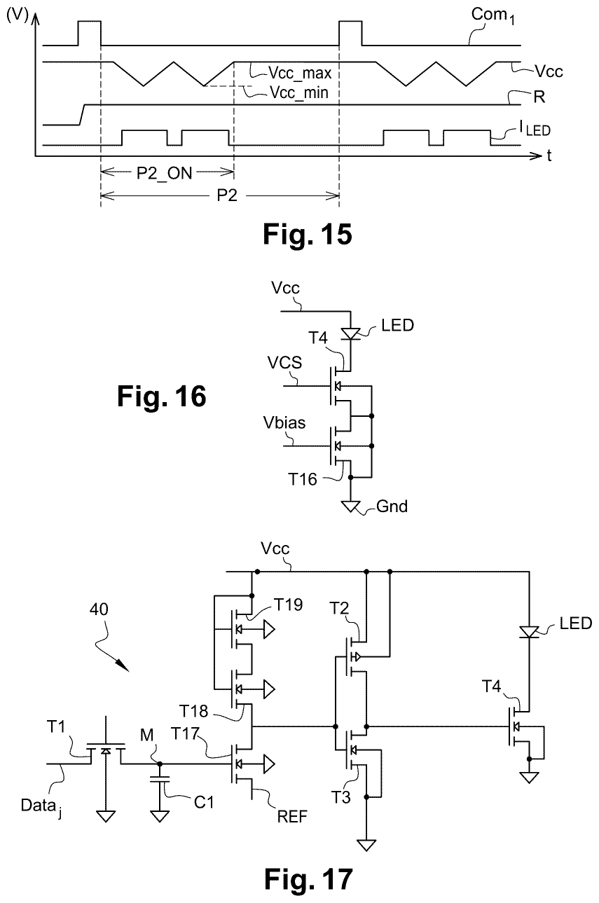

FIG. 15 is a drawing similar to FIG. 5 and shows timing diagrams of signals 12ᵢⱼ received by display pixels for another embodiment of a method of displaying an image on display screen 10. For illustration purposes, in FIG. 15, only the row of rank 1 has been considered.

The signal Comᵢ in FIG. 15 is identical to the signal Comᵢ of FIG. 5 with the difference that it does not comprise the succession of patterns during phase P2 but remains at the zero value during phase P2. In FIG. 15, high reference voltage Vcc is constant at a value Vcc_max except during the portion P2_ON of phase P2 during which it exhibits the repetition of patterns between maximum value Vcc_max and a minimum positive value Vcc_min. The shown driver circuit 40 may have the structure shown in FIG. 13. Driver circuit 40 may further comprise a circuit for delivering a stabilized high reference voltage based on signal Vcc.

FIG. 16 shows another embodiment of controllable current source CS. Controllable current source CS has the same structure as that shown in FIG. 10, with the difference that it comprises an N-channel MOS transistor T16 in series with MOS transistor T4, the drain of transistor T16 being coupled, preferably connected, to the drain of transistor T16, the source of transistor T16 being coupled, preferably connected, to the source of low reference potential Gnd, and the gate of transistor T16 receiving a constant voltage Vbias. The structure of the current source CS shown in FIG. 16 allows a more accurate current control of light-emitting diode LED.

FIG. 17 shows another embodiment of circuit 40 for driving controllable current source CS. Circuit 40 comprises all the elements shown in FIG. 10 with the difference that comparator COMP is replaced with an N-channel MOS transistor T17 having its source receiving signal REF, having its gate coupled, preferably connected, to node M and having its drain coupled, preferably connected, to the gates of transistors T2 and T3, and two N-channel MOS transistors T18 and T19, series-assembled between the drain of transistors T17 and the source of high reference voltage Vcc, the gates of transistors T18 and T19 being coupled, preferably connected, to the source of high reference voltage Vcc. Driver circuit 40 is particularly adapted to the case where the MOS transistors are replaced with thin film transistors, also called TFT transistors.

Simulations have been performed. For the simulations, driver circuit 40 has the structure shown in FIGS. 10 and 11.

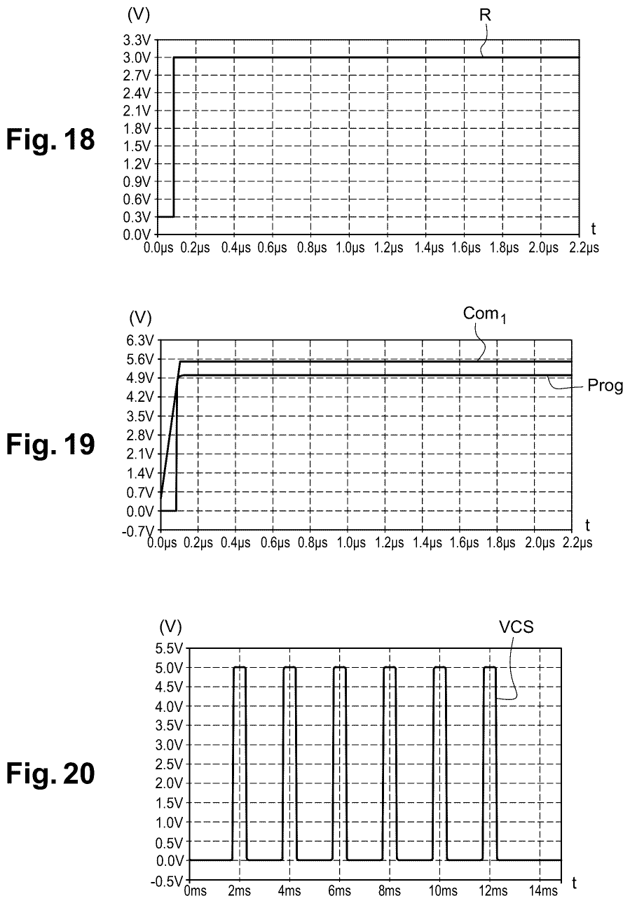

FIGS. 18 and 19 show timing diagrams of signals during a phase P1. More precisely, FIG. 18 shows the curve of variation of the voltage R across capacitor C1 and FIG. 19 shows curves of variation of signal Comᵢ and of signal Prog during phase P1.

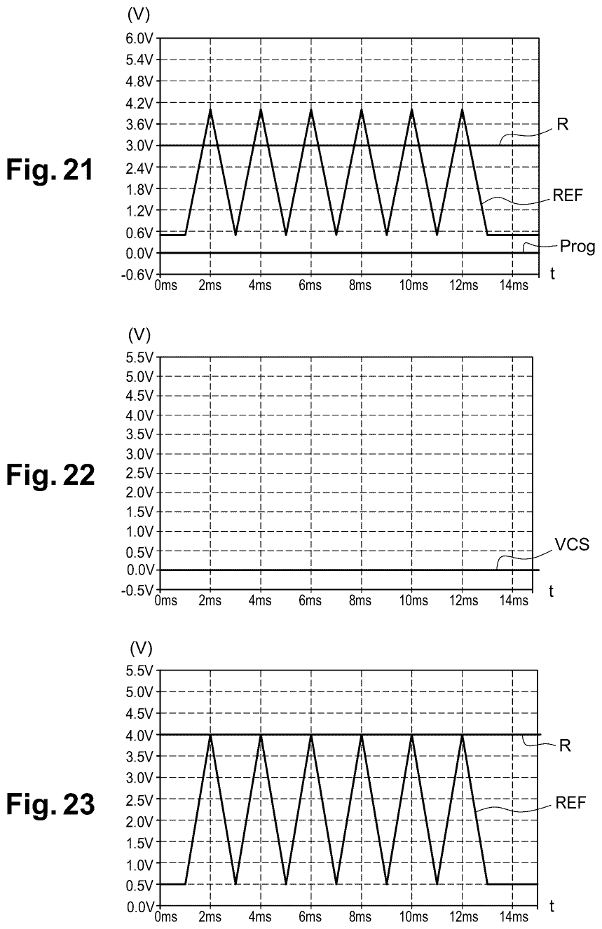

FIGS. 20 and 21 show timing diagrams of signals during a phase P2. More precisely, FIG. 20 shows the curve of variation of the gate voltage VCS of transistor T4 and FIG. 21 shows the curves of variation of signal Comᵢ, of signal Prog.

FIGS. 22 and 23 are respectively similar to FIGS. 20 and 21 in the case where the data signal transmitted to the display pixel has a maximum value, which corresponds to a light intensity received by the display pixel which is zero (VCS constant and equal to 0 V, the light-emitting diode being off all along phase P2).

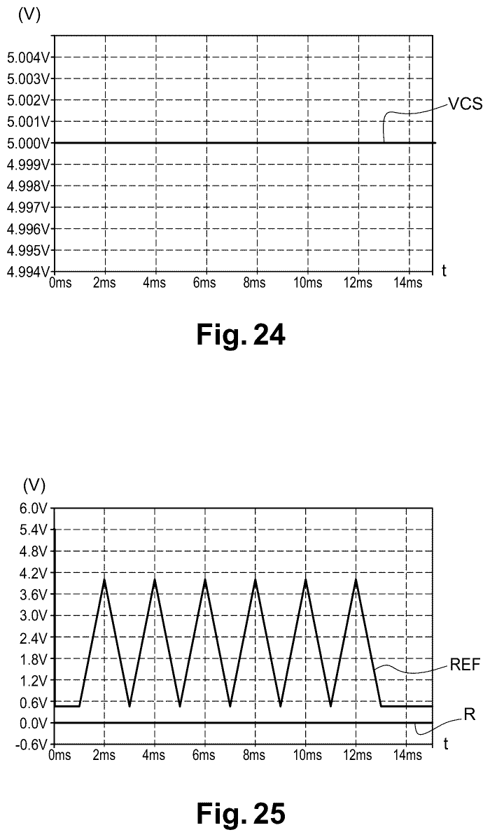

FIGS. 24 and 25 are respectively similar to FIGS. 20 and 21 in the case where the data signal transmitted to the display pixel has a minimum value, which corresponds to a light intensity received by the display pixel which is maximum (VCS constant and equal to 5 V, the light-emitting diode being on during the entire phase P2).

Specific embodiments have been described. Various alterations and modifications will readily occur to those skilled in the art. Further, various embodiments with various variations have been described hereabove. It should be noted that various elements of these various embodiments and variants may be combined. As an example, the embodiment of controllable current source CS shown in FIG. 16 may be implemented with the driver circuit 40 shown in FIG. 10, 14, or 17.

1. Display screen comprising:
display circuits, each display circuit comprising a light-emitting diode (LED), a controllable current source powering the light-emitting diode and a driver circuit adapted to delivering a signal, pulse-width modulated, for controlling the current source;
first electrodes coupled to the driver circuits;
a circuit for delivering a selection signal on each first electrode for the selection of the display circuits coupled to the first electrode;
second electrodes coupled to the driver circuits;
a circuit for delivering analog data signals (Dataⱼ) on the second electrodes, the driver circuit of each display circuit comprising a circuit configured to store the analog data signal received by the driver circuit when the display circuit is selected, and a circuit for comparing the analog data signal and an analog signal periodic per interval adapted to delivering the pulse-width modulated control signal;
third electrodes coupled to the driver circuits; and
a circuit for delivering a voltage for powering the light-emitting diodes on the third electrodes,
wherein each selection signal (Comᵢ) or the power supply voltage comprises spaced-apart phases, each containing the analog signal periodic per interval.

2. Display pixel according to claim 1, wherein each selection signal comprises successive pulses, each display circuit further comprising a detection circuit configured to detect each pulse of the selection signal that the display circuit receives and wherein the storage circuit of the display circuit is configured to store the analog data signal received by the driver circuit on detection of each pulse.

3. Display screen according to claim 2, wherein each selection signal comprises the phases interposed in time between two successive pulses.

4. Display circuit according to claim 3, wherein the detection circuit is configured to differentiate, in the selection signal, the pulses from the analog signal periodic per interval.

5. Display screen according to claim 4, wherein the maximum amplitude of the pulses of the selection signal is greater than the maximum amplitude of the analog signal periodic per interval.

6. Display screen according to claim 5, wherein the detection circuit comprises two successive inverters having different inversion thresholds.

7. Display screen according to claim 4, wherein the period of the analog signal periodic per interval on each interval is different from the duration of each pulse.

8. Display circuit according to claim 4, wherein the waveform of the pulses of the selection signal is different from the waveform of the analog signal periodic per interval over a period of the analog signal periodic per interval.

9. Display screen according to claim 8, wherein the detection circuit comprises a high-pass filter or a low-pass filter.

10. Display screen according to claim 2, wherein each driver circuit comprises a circuit for delivering a binary signal containing pulses simultaneous with the pulses of the selection signal.

11. Display screen according to claim 2, wherein the pulses and the phases of the analog signal periodic per interval are of signs opposite with respect to a reference value.

12. Display screen according to claim 1, wherein the signal periodic per interval is triangular.

13. Display screen according to claim 1, wherein the signal periodic per interval contains only successive ascending ramps or only successive descending ramps.

14. Display screen according to claim 1, wherein the driver circuit is configured to deliver the control signal in a first state when the analog data signal is greater than the analog signal periodic per interval and to deliver the control signal in a second state when the analog data signal is smaller than the analog signal periodic per interval.

15. Electronic system for delivering signals intended for an array of display circuits, each display circuit comprising a light-emitting diode, a controllable current source powering the light-emitting diode, and a driver circuit adapted to delivering a signal, pulse-width modulated, for controlling the current source, the array further comprising first, second, and third electrodes coupled to the driver circuits, the system comprising:
a circuit for delivering a selection signal on each first electrode;
a circuit for delivering analog data signals on the second electrodes, the driver circuit of each display circuit comprising a circuit for storing the analog data signal received by the driver circuit and a circuit for comparing the analog data signal and an analog signal periodic per interval adapted to delivering the pulse-width modulated control signal; and
a circuit for delivering a voltage for powering the light-emitting diodes on the third electrodes,
wherein each selection signal or the power supply voltage comprises spaced-apart phases, each containing the analog signal periodic per interval.

16. Electronic system according to claim 15, wherein each selection signal comprises successive pulses.

17. Electronic system according to claim 16, wherein each selection signal comprises the phases interposed in time between two successive pulses.

18. Electronic system according to claim 17, wherein the waveform of the pulses of the selection signal is different from the waveform of the analog signal periodic per interval over a period.

19. Electronic system according to claim 16, wherein the maximum amplitude of the pulses of the selection signal is greater than the maximum amplitude of the analog signal periodic per interval.

20. Electronic system according to claim 16, wherein the period of the analog signal periodic per interval on each interval is different from the duration of each pulse.

21. Electronic system according to claim 16, wherein the pulses and the phases of the analog signal periodic per interval are of signs opposite with respect to a reference value.

22. Electronic system according to claim 16, wherein the signal periodic per interval is triangular.

23. Electronic system according to claim 16, wherein the signal periodic per interval contains only successive ascending ramps or only successive descending ramps.
